(19) United States
(12) Patent Application Publication
(10) Pub. No.: US 2025/0386154 A1
(43) Pub. Date: Dec. 18, 2025

(54) CONVERSATION ASSISTANCE DEVICE

(71) Applicants: Cosmogear Co., Ltd., Osaka (JP); Taieisangyo Co., Ltd., Tokushima (JP)

(72) Inventors: Hidenori Nakatani, Osaka-shi, Osaka (JP); Hiroyasu Kawamata, Yoshinogawa-shi, Tokushima (JP)

(21) Appl. No.: 18/833,284

(22) PCT Filed: Mar. 27, 2023
(86) PCT No.: PCT/JP2023/012291

§ 371 Date: Mar. 4, 2025

(30) Foreign Application Priority Data
Jul. 12, 2022 (JP) 2022-111511

(51) Int. Cl. H04R 25/00

(52) U.S. Cl. CPC H04R 25/606

(57) ABSTRACT

A vibration device is connected to a body part. The vibration device is coupled to the body part by a coupling part. Audio obtained by a microphone is input, as an electrical signal, into a bone conduction device, the bone conduction device being capable of converting the electrical signal into mechanical vibrations, applying the vibrations to bone from an appropriate position to transmit the vibrations to the bone, and using bone conduction sound transmitted by the vibrations to make the sound recognized. A mounting part is provided on the inner surface side (the surface side in the same direction as a vibration surface of the vibration device) of the body part. A holding member for holding the body part on a user can be attached to and removed from the mounting part.

### TECHNICAL FIELD

The present invention relates to a conversation assistance device that enables communication with people having hearing difficulties.

### BACKGROUND OF THE INVENTION

People with hearing impairments, for example, have conventionally used hearing aids to have conversations more efficiently. Hearing aids use a mechanism in which audio detected by a microphone is amplified and converted into air vibrations, which are then transmitted to one's eardrum so that vibrations of the eardrum pass through the middle ear deep inside the ear to transmit audio information to the brain to be recognized. However, an ordinary hearing aid functions only as an earphone simply increasing the volume of the sound detected by the microphone and transmitting the audio to the person with hearing impairments. Continuous use of such the hearing aid for long hours may rather cause damages to the eardrum, and many of such the hearing aids may give users feeling of tiredness.

As a countermeasure, hearing devices utilizing bone conduction have been proposed. A hearing device utilizing bone conduction converts audio signals that have been input as electrical signals into mechanical vibrations and applies the vibrations to bone from an appropriate position to transmit the vibrations to the bone so that bone conduction sound transmitted by the vibrations can be recognized as sounds. Such the hearing device utilizing bone conduction does not use vibrations of an eardrum, thereby allowing people with hearing impairments to recognize sounds, and applications thereof to hearing aids and the like have been advancing (Japanese Unexamined Patent Application Publication No. H02-62199 (JP-A-H02-62199), for example).

Utilization of bone conduction as above enables people with hearing impairments to have conversations etc. without burdening their eardrums. However, conventional bone conduction devices have not always been user-friendly. For example, although a common bone conduction device is used when being fitted onto a head, each user feels differently as to how to wear the device for comfortable fitting and usability. For this reason, a bone conduction device that is wearable in a fixed way may be comfortable for some people but may be uncomfortable for others. That is, the user has to find a bone conduction device that has a suitable fitting method for him or her, and this has been a factor that narrows a range of choice.

Also, if the user of the bone conduction device (a person with hearing impairments) is confined to bed in a hospital or in a nursing home, it is sometimes difficult for the user to wear the bone conduction device on his or her head. In such the case, it is a burden for both the person with hearing impairments and a care worker or a nurse, who is to put the bone conduction device on the person's head, each time the person has a conversation with the care worker or the nurse. For this reason, a communication tool that is easy to use for many more users and allows people with hearing impairments to have conversations easier in various situations has been awaited.

### SUMMARY OF THE INVENTION

The present invention was made in view of such problems. It is an object of the present invention to provide a conversation assistance device of which usage can be changed according to a user, and which allows a person with hearing impairments to enjoy conversations.

To achieve the above object, one aspect of the present invention is a conversation assistance device utilizing bone conduction. The conversation assistance device includes a body part and a vibration device that is connected to the body part. The body part includes a microphone, a control unit for controlling the conversation assistance device, an operation panel for operating the conversation assistance device, and a mounting part that can attach and detach a holding member for holding the body part to the user. The control unit enables the vibration device to vibrate in accordance with audio information received by the microphone. In a state in which the holding member is mounted onto the mounting part, the holding member holds the body part on a user's head so that the vibration device can be in contact with a part of the user's head. In a state in which the holding member is detached from the mounting part, a user can use the conversation assistance device by holding the body part in hand and bringing the vibration device in contact with a person to talk to.

The vibration device is coupled to the body part by a coupling part. The coupling part may be formed of an elastic member and may have an adjustment mechanism that can adjust a position and a direction of the vibration device with respect to the body part.

The microphone may be disposed on one surface of the body part and a part at which the microphone is mounted may protrude more than other parts of the surface of the body part.

The vibration device may include a sensor that detects whether the vibration device is pressed against a target part or not. If the vibration device is not pressed against the target part, the control unit keeps the conversation assistance device on standby. If the vibration device is pressed against the target part, the control unit may start operating the conversation assistance device.

An external input terminal may be provided on the body part, and audio information received by a device that is connected to the external input terminal can be input. The control unit may be able to choose, by means of the operation panel, which audio information is to be transmitted to the vibration device: either the audio information from the device connected to the external input terminal, the audio information obtained by the microphone, or combination of the above.

According to the present invention, the body part is detachable with respect to the holding member, and thus the body part can be mounted onto the holding member that is suitable for the user. For example, the holding member in a headband shape can be used to fix the body part to one's head. Alternatively, the body part can also be mounted onto a rim of a cap or the like that the user usually wears. Thus, the user can choose and use the holding member that suits him or her.

It is also possible to use the conversation assistance device by holding the body part in hand, without using the holding member. Thus, when talking to a user in a hospital or in a care facility, for example, a nurse or a care worker can bring the vibration device in contact with the user's head or the like to have conversations.

Also, an elastic member can couple the vibration device with the body part having the built-in microphone, and this can prevent howling or the like that occurs when vibrations of the vibration device are transmitted to the microphone. Also, the position adjustment mechanism of the vibration device is provided at the coupling part, and this can make sure that the vibration device is in contact with the target part of the user.

Also, the microphone disposed on the body part protrudes more than the other parts, and thus not only this facilitates collection of audio but also this can prevent the user from wrongly covering the microphone part with fingers when the body part is held in hand.

Also, the sensor for detecting whether the vibration device is pressed against the target part or not is provided. Thus, when the vibration device is not pressed against the target part, the conversation assistance device is kept on standby, which enables to stop unnecessary operations of the vibration device when being unused. Also, the vibration device starts operating when the vibration device is pressed with a certain pressing force against the target part. This allows the user to know how strongly the vibration device is to be pressed against the other person when the user holds the vibration device in hand and brings the vibration device in contact with the other person, for example.

Also, the external input terminal is provided on the body part and audio information from the device connected to the external input terminal can be input into the conversation assistance device. This allows the user to listen to conversations on a mobile phone or to music. In addition, a microphone as an external device can also be connected. For example, when the user wants to have a conversation with a person on the other side of a screen partition or the like in a bank or in a public office, the microphone alone may be disposed on the other side of the partition (on a side of the other person) so that the user can hear the other person's voice more clearly. At this time, the user may be able to choose, by using the operation panel, to hear audio information from the built-in microphone of the body part or audio information from the external input terminal. It is also possible to combine both the audio information to be heard.

The present invention can provide a conversation assistance device of which usage can be changed according to a user, and which allows a person with hearing impairments to enjoy conversations.

### BRIEF DESCRIPTION OF DRAWINGS

FIG. 1 is a view showing a conversation assistance device 1.

FIG. 2A is a view showing an example of a method of using the conversation assistance device 1.

FIG. 2B is a view showing the example of the method of using the conversation assistance device 1.

FIG. 3 is a view showing a state in which the conversation assistance device 1 is being used.

FIG. 4 is a view showing another state in which the conversation assistance device 1 is being used.

FIG. 5 is a block diagram of the conversation assistance device 1.

FIG. 6 is a view showing a movement of the conversation assistance device 1.

FIG. 7A is a view showing a conversation assistance device 1a.

FIG. 7B is a view showing the conversation assistance device 1a.

FIG. 8 is a block diagram of the conversation assistance device 1a.

### DETAILED DESCRIPTION

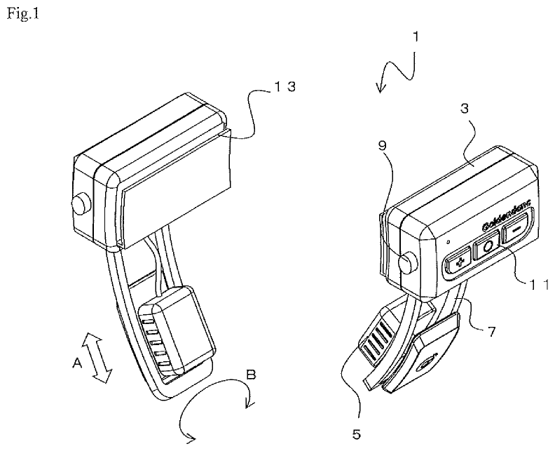

Hereinafter, a first embodiment of the present invention will be described with reference to the accompanying drawings. FIG. 1 is a view showing a conversation assistance device 1 according to the present embodiment. Each of a pair of the conversation assistance devices 1 utilizing bone conduction includes a body part 3, a vibration device 5, and so on.

The body part 3 includes a microphone 9, an operation panel 11 for operating the conversation assistance device 1, a mounting part 13 that can attach and detach a holding member, a control unit for controlling the conversation assistance device 1, and so on. Batteries driving the conversation assistance device 1 may be rechargeable, or may be dry cells or button cells.

The microphone 9 is disposed on one of the surfaces of the body part 3. For example, for a pair of the body parts 3, the microphones 9 are disposed symmetrically to each other. Also, a part on which the microphone 9 is disposed protrudes more than other parts of the surface of the body part 3. An analog microphone is preferable as the microphone.

The operation panel 11 is provided on another surface of the body part 3. The operation panel 11 can perform various operations on the device such as on and off of power and adjustment of volume (adjustment of vibration output). The operation panel 11 may also be provided with an indicator (lamps) or the like that indicates on and off of the power or remaining battery capacity, as necessary.

The vibration device 5 is connected to the body part 3. The vibration device 5 is coupled to the body part 3 by a coupling part 7. The coupling part 7 is formed of an elastic member made of metal or resin. Also, the coupling part 7 can slide (extensible) with respect to the body part 3 (in a direction shown by an arrow A in the drawing). Also, the coupling part 7 can adjust a direction of a contacting surface of the vibration device 5 (in a direction shown by an arrow B in the drawing). That is, the coupling part 7 has an adjustment mechanism that can adjust a position and a direction of the vibration device 5 with respect to the body part 3.

Audio obtained by the microphone 9 is input as electrical signals into the vibration device 5, and the vibration device 5 converts the electrical signals into mechanical vibrations and applies the vibrations to bone from an appropriate position to transmit the vibrations to the bone such that bone conduction sound transmitted by the vibrations can be recognized as sounds. In the present invention, any of unlimited vibration methods that can convert audio electrical signals into mechanical signals may be used in the vibration device 5, and known methods such as a piezoelectric type, a magnetic type, or a super-magnetostrictive type may be adopted.

The mounting part 13 is provided on an inner surface side of the body part 3 (on a surface side in substantially the same direction of a vibration surface of the vibration device 5). A holding member for holding the body part 3 to the user can be attached to or detached from the mounting part 13.

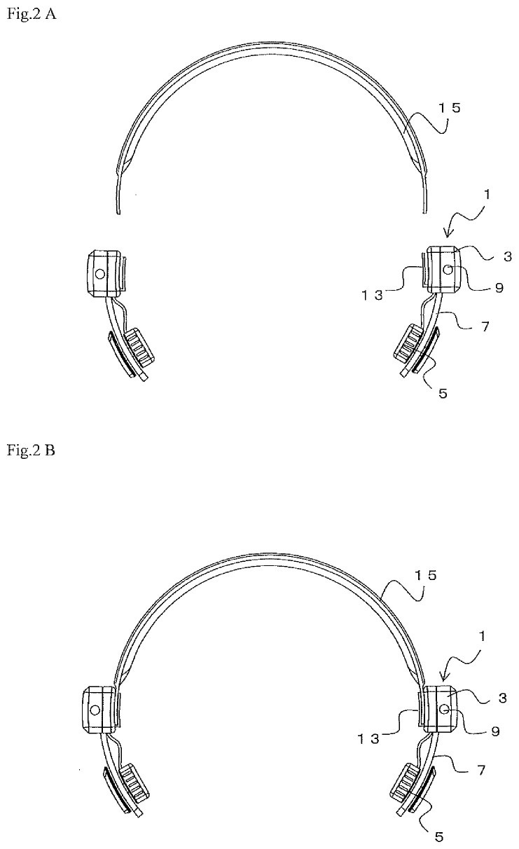

FIG. 2A is a view showing a method of mounting a holding member 15 onto the conversation assistance device 1. In the illustrated example, the holding member 15 is a headband-shaped elastic member that can be fitted onto a user's head. As shown in FIG. 2B, a tip end of the holding member 15 is inserted into the mounting part 13 such that the holding member 15 and the conversation assistance device 1 can be connected to each other. Also, dissembling can be done easily by pulling out the holding member 15 from the mounting part 13.

The mounting part 13 may be an elastically deformable clip, for example, that can hold and fix the tip end of the holding member 15. Alternatively, the mounting part 13 may have an opening-closing structure, in which the tip end of the holding member 15 inserted into the opening mounting part 13 can be fixed by closing the mounting part 13. Furthermore, a driving screw or the like may be provided such that, after the tip end of the holding part 15 is inserted, the driving screw can be driven to fix the holding part 15. Also, the mounting part 13 may be provided with a hook or a pin so as to fix the holding member.

Also, the holding member 15 may be in any shape other than the headband type as illustrated in the drawings. For example, the conversation assistance device 1 can be attached to a cap by inserting a rim of the cap into the mounting part 13 to be fixed. Moreover, the holding member may be a member that is worn around a head such as a hair band. Also, instead of fixing the holding member directly to the mounting part 13, an attachment is fixed to the mounting part 13 and the holding member can be fixed via the attachment. In any ways, the holding member is fixed to the mounting part 13 so that the conversation assistance device 1 can be held to the user's head.

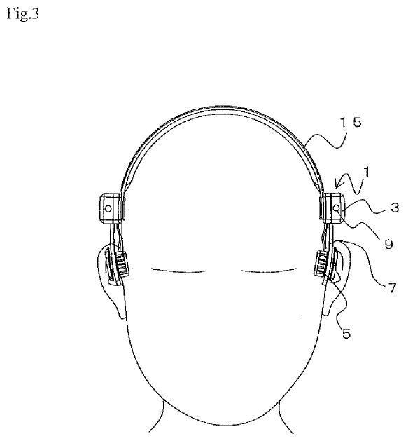

FIG. 3 is a view showing an example of a state in which the user wears the conversation assistance device 1. The holding member 15 fixes the pair of the conversation assistance devices 1 such that the vibration surfaces of the vibration devices 5 are in contact with parts of the user's head. The position of the vibration device 5 is not particularly limited as long as the vibration device 5 can be in contact with a part of the user's head. For example, the vibration devices 5 may be disposed around temples as shown in the illustration, or at the back of ears.

Also, although the microphone 9 of each conversation assistance device 1 is disposed being directed toward a front of the body part 3 (toward a person to talk to), the microphone 9 may be disposed in other ways. For example, the microphone 9 may be disposed being directed toward both outer surface sides of the body part 3 of each conversation assistance device 1. Moreover, to prevent vibrations of the vibration device 5 or vibrations of the user's voice from being transmitted to the microphone 9, a flexible vibration control member may be disposed at a part of a housing of the body part 3 to which the microphone 9 is mounted.

As mentioned above, the control unit accommodated in the body part 3 can vibrate the vibration device 5 in accordance with audio information received by the microphone 9. Thus, when the microphone 9 picks up the other person's voice, the control unit converts the voice to electrical signals and vibrates the vibration device 5. Vibrations from the vibration device 5 are transmitted by bone conduction, and thus the user can hear the voice.

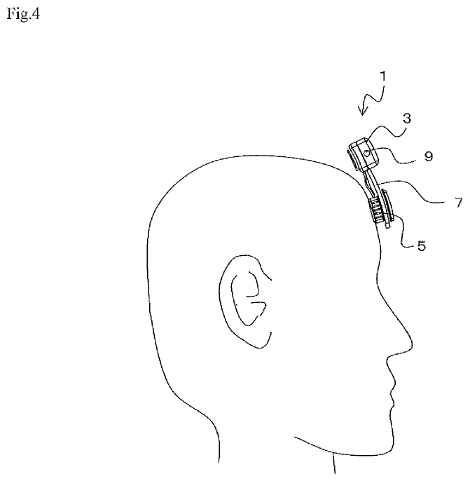

FIG. 4 is a view showing another method of using the conversation assistance device 1. As mentioned above, the holding member 15 can be attached to and detached from the conversation assistance device 1. Thus, the conversation assistance device 1 can be used in a state in which the holding member 15 is detached from the mounting part 13. In such the case, a user can hold the body part 3 in hand and bring the vibration surface of the vibration device 5 in contact with a person to talk to.

So, for a user who is confined to bed, for example, the user can easily hear audio by bone conduction if a care worker or the like brings the vibration device 5 in contact with the user's forehead to have conversations. As above, the conversation assistance device 1 can be used without the holding member and thus can be applied in situations in which it is difficult for the user to put on the holding member.

It is difficult to handle the body part 3 if the body part 3 is too small when used being held in hand. Thus, a size of a long side of the body part 3 (a direction vertical to the paper in FIG. 4) is preferably 48 mm or more, for example. In this way, an AAA size battery can be used, thereby eliminating charging operations or the like. Also, if the body part 3 has a length closer to 50 mm, handling of the device, that is, holding the device in hand and pressing the vibration device 5 against the other person, becomes easier. Although a longitudinal direction of the body part 3 is perpendicular to a connection direction with the vibration device 5 in the example shown in FIG. 1, the longitudinal direction of the body part 3 may be parallel to the connection direction of the vibration device 5.

Here, if the body part 3 is used being held in hand with fingers blocking the microphone 9, the microphone 9 is unable to receive the audio sufficiently. However, the part of the microphone 9 protrudes more than the other parts and it is easy to recognize the position of the microphone 9. Thus, by avoiding the protruding part when holding the body part 3 in hand, it is possible to prevent blocking of the microphone 9 with fingers.

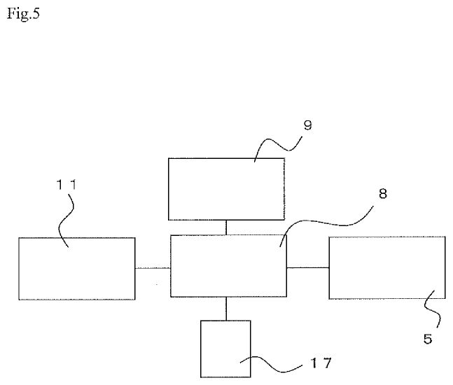

Next, a method of controlling the conversation assistance device 1 will be described in detail. FIG. 5 is a block diagram showing a structure of the conversation assistance device 1. Structures such as a power supply are omitted. As described above, the control unit 8 can perform various operations such as on and off of the power and settings for volume etc. through the operation panel 11. Also, the control unit 8 can process audio information (electrical signals) obtained by the microphone 9 in a predetermined way to be transmitted to the vibration device 5.

Here, as shown in FIG. 4 for example, when the conversation assistance device 1 is used being held in hand, it is useless and wasteful consumption of power to vibrate the vibration device 5 in a state in which the vibration device 5 is not pressed against a user.

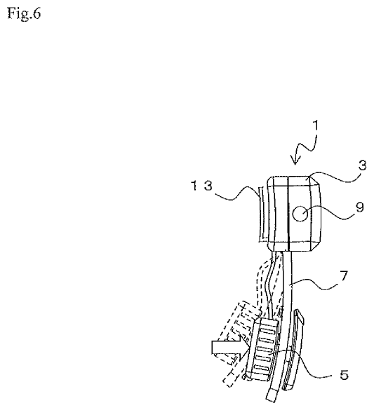

For this reason, a sensor 17 for detecting whether the vibration device 5 is pressed against a target part with a force greater than a predetermined strength may be used. FIG. 6 is a view showing a state in which the vibration device 5 is pressed with a force greater than the predetermined strength.

When the vibration device 5 is not pressed against the target part with the force greater than the predetermined strength, the control unit 8 keeps the conversation assistance device 1 on standby. That is, the control unit 8 stops operating the microphone 9 and the vibration device 5. In contrast, when the vibration device 5 is pressed against the target part with the force greater than the predetermined strength, the control unit 8 starts operating the conversational assistance device 1 (the microphone 9 and the vibration device 5). The sensor 17 may be a sensor that detects pressure on the contacting surface of the vibration device 5, or a sensor that detects deformation volume (an amount of sagging) or stress of the coupling part 7, which is an elastic body.

It is also difficult to find out how much force should be applied when pressing the conversational assistance device 1 to the other person's head. For example, if pressing force of the vibration device 5 is insufficient, the vibrations may not be efficiently transmitted to bone and the user may find it difficult to hear the sound. On the other hand, if too much pressing force is applied, the user may feel pain or discomfort.

So, the conversation assistance device 1 may be provided with an indicator (a lamp, etc.) that indicates a status in which the sensor 17 detects that the vibration device 5 is pressed against the target part with an appropriate force and the control unit 8 starts operating the microphone 9 and the vibration device 5. Also, if the force applied is too strong, a warning may be made by changing the color of the lamp or the like. In this way, the vibration device 5 can be pressed against the other person with an appropriate force.

An operation control by the sensor 17 may also be carried out similarly when the holding member 15 is mounted. However, on and off of the power on the operation panel 11 may be prioritized when the holding member is mounted onto the mounting part 13. That is, another sensor for detecting whether the holding member is inserted into the mounting part 13 or not may be provided, and, when the holding member is used, the operation control by the pressing force of the vibration device 5 (controlled by the sensor 17) may be on hold and the operation control is carried out by operating on the operation panel 11.

As mentioned above, the holding member can be selected from various types, and an arrangement of the vibration device 5 also depends on the type of the holding member being used. Thus, the appropriate pressing force for the vibration device 5 may vary in accordance with different contacting parts of the head. On the other hand, as mentioned above, the coupling part 7 has the adjustment mechanism that can adjust the position and the direction, and thus the user can adjust by using the adjustment mechanism to obtain the appropriate pressing force for oneself. Also, if the holding member is put on the head, this usually means that the conversation assistance device 1 is in use and thus the device is preferably in operation at all times. For this reason, there is no need to use the automatic operation control by the sensor, and the power is to be turned off by operating on the operation panel 11 when the holding member is removed from the head.

The conversation assistance device 1 may also be provide with another sensor such as a vibration sensor or an acceleration sensor such that the power may be automatically turned off (on standby) when there is no motion of the conversation assistance device 1 for more than a predetermined period of time, and the power may be automatically turned on (in operation) when there is a motion of the conversation assistance device 1, by being lifted up by hand or the like. This can reduce consumption of electricity even if the user forgets to turn off the power. The above-mentioned operation controls by the various sensors may also be combined with one another.

As above, the conversation assistance device 1 according to the first embodiment utilizes bone conduction, thereby allowing people with hearing impairments to have conversations without feeling stressed. Also, the holding member is detachable and a user can choose and wear the holding member that is suitable for the user.

Also, the conversation assistance device 1 can be used on its own, with the holding member being detached. Thus, the conversation assistance device 1 can be used by a bedridden user or the like, who finds it difficult to wear the holding member on his or her head. At this time, the body part 3 is made to be in a substantially rectangular parallelepiped shape (a shape having, other than the operation panel surface, at least a pair of facing surfaces that can be held in hand) having a size that is greater than a predetermined size. This facilitates handling of the body part 3 when held in hand and also enables dry cells to be used.

Also, the microphone 9 protrudes more than a surface of the body part 3. This facilitates to recognize the position of the microphone 9 when being held in hand and prevents the user from wrongly covering the microphone 9 with fingers.

Also, the coupling part 7 is provided with the adjustment mechanism that can adjust the position and the direction of the vibration device 5, and thus the vibration device 5 can be disposed at a position that is appropriate for the user. Also, the coupling part 7 is formed of an elastic member and this can prevent howling that occurs when vibrations of the vibration device 5 are transmitted to the microphone 9 of the body part 3.

Also, the sensor 17 allows the device to switch between a standby state and an operation state. Thus, when not being used, the device is switched to the standby state so as to save the electricity consumption, and when being used, the device is automatically switched to the operation state. Also, the sensor 17 can detect whether the vibration device 5 is pressed against the target part with the appropriate pressing force or not, and the indicator indicates a pressing status. Thus, the vibration device 5 can be pressed against a forehead or the like of the other person with an appropriate force.

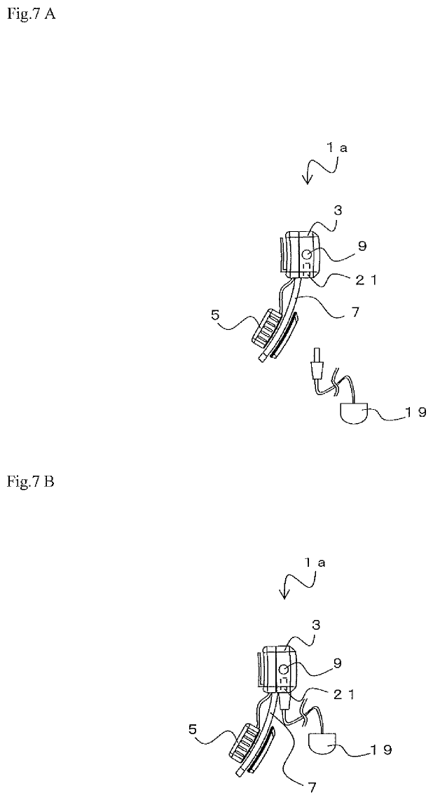

Next, a second embodiment of the present invention will be described. FIG. 7A and FIG. 7B are views showing a method of using a conversation assistance device 1a according to the second embodiment. In the descriptions hereafter, structures having the same functions as in the first embodiment will have the same notations as in FIG. 1 to FIG. 6 and redundant descriptions thereof will be omitted.

The second embodiment has approximately the same structure as the first embodiment except that the body part 3 is provided with an external input terminal 21. A device 19 can be connected to the external input terminal 21. Although the external input terminal 21 may be provided on one of the pair of the conversation assistance devices 1a, it is preferable that the external input terminal 21 is provided on each of the pair of the conversation assistance devices 1a.

Devices such as a mobile terminal, a music player, and an external microphone may be used as the device 19. By connecting the device 19 to the body part 3, audio information from the device 19 can be input into the conversation assistance device 1a and then output to the vibration device 5.

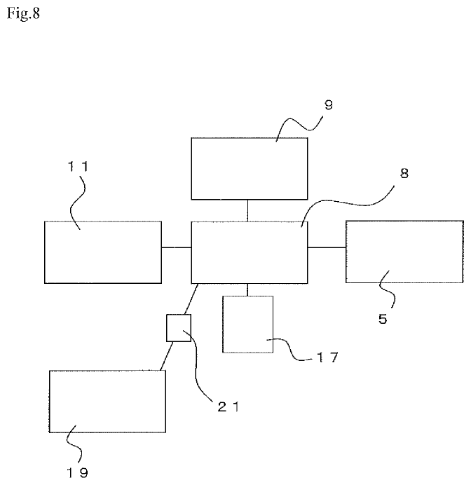

FIG. 8 is a block diagram of the conversation assistance device 1a in such the state. In such the case, audio information from the microphone 9 and audio information from the device 19 are input into the control unit 8. At this time, by switching on the operation panel 11, the control unit 8 can choose between the audio information from the device 19 connected to the external input terminal 21 and the audio information obtained by the microphone 9 to be output to the vibration device 5.

Also, by switching on the operation panel 11, it is possible to combine the audio information from the device 19 connected to the external input terminal 21 with the audio information obtained by the microphone 9, and to transmit the combined audio information to the vibration device 5. For example, the user can hear surrounding sounds through the microphone 9 while having a conversation on a mobile phone used as the device 19. Similarly, the user can hear surrounding sounds through the microphone 9 while listening to music on the device 19.

Also, if the device 19 is an external microphone, the user may switch between the microphone 9 and the device 19 (the external microphone), or may choose combination of both. For example, in a bank or in a public office, there may be a partitioning screen between the user and a person to speak to, and it is sometimes difficult to hear the voice of the other person through the microphone 9. Raising the volume, however, may also increase the volume of surrounding sounds, which makes it more difficult to hear due to noise.

In such the case, an external microphone may be connected to the external input terminal 21 and the external microphone may be disposed toward the other person through a gap in the partitioning screen. This can reduce influence of the partitioning screen and allows the user to hear the other person's voice easily and more efficiently. In such the case, the user may use only the external microphone, with the microphone 9 being turned off, or may combine the audio information from the microphone 9 and the external microphone.

According to the second embodiment, the same effects as in the first embodiment can be obtained. Also, by connecting the device 19 through the external input terminal 21, the user can listen to audio information from a device other than the microphone 9. At this time, by using the external microphone, the user can have conversations efficiently in various situations.

Although the embodiments of the present invention have been described referring to the attached drawings, the technical scope of the present invention is not limited to the embodiments described above. It is obvious that persons skilled in the art can think out various examples of changes or modifications within the scope of the technical idea disclosed in the claims, and it will be understood that they naturally belong to the technical scope of the present invention.

1. A conversation assistance device utilizing bone conduction, the conversation assistance device comprising:
a body part; and
a vibration device that is connected to the body part, wherein:
the body part includes a microphone, a control unit for controlling the conversation assistance device, an operation panel for operating the conversation assistance device, and a mounting part that can attach and detach a holding member for holding the body part to a user;
the control unit enables the vibration device to vibrate in accordance with audio information received by the microphone;
in a state in which the holding member is mounted onto the mounting part, the holding member holds the body part on a user's head so that the vibration device can be in contact with a part of the user's head; and
in a state in which the holding member is detached from the mounting part, a user can use the conversation assistance device by holding the body part in hand and bringing the vibration device in contact with a person to talk to.

2. The conversation assistance device according to claim 1, wherein:
the vibration device is coupled to the body part by a coupling part;
the coupling part is formed of an elastic member; and
the coupling part includes an adjustment mechanism that can adjust a position and a direction of the vibration device with respect to the body part.

3. The conversation assistance device according to claim 1, wherein the microphone is disposed on one surface of the body part and a part at which the microphone is mounted protrudes more than other parts of said surface of the body part.

4. The conversation assistance device according to claim 1, wherein:
the vibration device includes a sensor that detects whether the vibration device is pressed against a target part or not;
in a state in which the vibration device is not pressed against the target part, the control unit keeps the conversation assistance device on standby; and
in a state in which the vibration device is pressed against the target part, the control unit starts operating the conversation assistance device.

5. The conversation assistance device according to claim 1, wherein:
the body part is provided with an external input terminal, and audio information received by a device that is connected to the external input terminal can be input; and
the control unit can choose, by means of the operation panel, which audio information is to be transmitted to the vibration device: either the audio information from the device connected to the external input terminal, the audio information obtained by the microphone, or combination of both.
